(19) United States
(12) Patent Application Publication
(10) Pub. No.: US 2022/0264631 A1
(43) Pub. Date: Aug. 18, 2022

(54) Methods, Terminal Device and Network Node for Uplink Transmission

(71) Applicant: Telefonaktiebolaget LM Ericsson (publ), Stockholm (SE)

(72) Inventors: Min Wang, Luleå (SE); Jinhua Liu, Beijing (CN)

(21) Appl. No.: 17/626,248

(22) PCT Filed: Apr. 10, 2020
(86) PCT No.: PCT/CN2020/084170

§ 371 Date: Jan. 11, 2022

(30) Foreign Application Priority Data
Jul. 12, 2019 (CN) PCT/CN2019/095817

(51) Int. Cl. H04W 72/14; H04W 72/12; H04W 72/04; H04W 74/08; H04L 5/00; H04L 1/18

(52) U.S. Cl. CPC H04W 72/14; H04W 72/1263; H04L 1/1812; H04W 74/0816; H04L 5/0053; H04W 72/044

(57) ABSTRACT

Methods, a terminal device and a network node are disclosed for uplink transmission. According to an embodiment, the terminal device triggers a scheduling request (SR) to request an uplink grant upon a preconfigured number of uplink transmission failures when using configured grants. The terminal device transmits the SR to a network node.

### TECHNICAL FIELD

Embodiments of the disclosure generally relate to wireless communication, and, more particularly, to methods, a terminal device and a network node for uplink transmission.

### BACKGROUND

This section introduces aspects that may facilitate better understanding of the present disclosure. Accordingly, the statements of this section are to be read in this light and are not to be understood as admissions about what is in the prior art or what is not in the prior art.

The 5th generation of cellular system, called new radio (NR) is developed for maximum flexibility to support multiple and substantially different use cases. Besides the typical mobile broadband use case, there are also machine type communication (MTC), ultra-low latency critical communications (ULLCC), side-link device-to-device (D2D) and several other use cases.

NR supports flexible bandwidth configurations for different user equipments (UEs) on the same serving cell. In other words, the bandwidth monitored by a UE and used for its control and data channels may be smaller than the carrier bandwidth. One or multiple bandwidth part (BWP) configurations for each component carrier can be semi-statically signaled to a UE, where a BWP consists of a group of contiguous physical resource blocks (PRBs). Reserved resources can be configured within the BWP. The bandwidth of a BWP equals to or is smaller than the maximal bandwidth capability supported by a UE.

NR is targeting both licensed and unlicensed bands. Allowing unlicensed networks, i.e., networks that operate in shared spectrum (or unlicensed spectrum) to effectively use the available spectrum is an attractive approach to increase system capacity.

When operating in unlicensed spectrum, many regions in the world require a device to sense the medium as free before transmitting. This operation is often referred to as listen before talk or LBT for short. It is designed for unlicensed spectrum co-existence with other radio access technologies (RATs). For this mechanism in NR unlicensed spectrum, a radio device applies a clear channel assessment (CCA) check (i.e. channel sensing) before any transmission. The transmitter involves energy detection (ED) over a time period compared to a certain threshold (ED threshold) in order to determine if a channel is idle. In case the channel is determined to be occupied, the transmitter performs a random back-off within a contention window before next CCA attempt. In order to protect the acknowledgement (ACK) transmissions, the transmitter must defer a period after each busy CCA slot prior to resuming back-off. As soon as the transmitter has grasped access to a channel, the transmitter is only allowed to perform transmission up to a maximum time duration (namely, the maximum channel occupancy time (MCOT)). For quality of service (QoS) differentiation, a channel access priority based on the service type has been defined. For example, there are four LBT priority classes defined for differentiation of contention window sizes (CWS) and MCOT between services.

There are many different flavors of LBT, depending on which radio technology the device uses and which type of data it wants to transmit at the moment. Common for all flavors is that the sensing is done in a particular channel (corresponding to a defined carrier frequency) and over a predefined bandwidth. For example, in the 5 GHz band, the sensing is done over 20 MHz channels.

Many devices are capable of transmitting (and receiving) over a wide bandwidth including multiple sub-bands/channels, e.g., LBT sub-band (i.e., the frequency part with bandwidth equals to LBT bandwidth). A device is only allowed to transmit on the sub-bands where the medium is sensed as free.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for uplink transmission.

According to a first aspect of the disclosure, there is provided a method in a terminal device. The method comprises triggering a scheduling request, SR, to request an uplink grant upon a preconfigured number of uplink transmission failures when using configured grants. The method further comprises transmitting the SR to a network node.

In an embodiment of the disclosure, the uplink transmission failures comprise at least one of: a listen before talk, LBT, failure; a negative acknowledgement is received after an uplink transmission; neither positive nor negative acknowledgement is received after an uplink transmission; expiration of a configured grant timer associated with the uplink transmission; and expiration of a configured grant retransmission timer associated with the uplink transmission.

In an embodiment of the disclosure, the preconfigured number of uplink transmission failures comprises consecutive or non-consecutive uplink transmission failures.

In an embodiment of the disclosure, the uplink transmission is performed with a hybrid automatic repeat request, HARQ, process, the negative acknowledgement is a HARQ NACK, and the positive acknowledgement is a HARQ ACK.

In an embodiment of the disclosure, the SR is triggered per SR configuration, and the SR configuration is associated with at least one of: LBT channel, LBT sub-band, bandwidth part, BWP, cell, carrier, cell group, service, Logic Channel, LCH, and Logical Channel Group, LCG.

In an embodiment of the disclosure, the method further comprises transmitting a report indicating a SR triggering cause to the network node.

In an embodiment of the disclosure, the method further comprises cancelling a pending SR when at least one LBT process successes; or cancelling a pending SR when at least one positive acknowledgement for the uplink transmission is received.

In an embodiment of the disclosure, the SR is transmitted via a Physical Uplink Control Channel, PUCCH, or a Random Access Channel, RACH, procedure to the network node.

In an embodiment of the disclosure, the method further comprises receiving at least one updated configured grant from the network node.

In an embodiment of the disclosure, the at least one updated configure grant is per LBT channel, LBT sub-band, BWP, cell, or carrier.

In an embodiment of the disclosure, the method further comprises receiving an uplink grant from the network node.

In an embodiment of the disclosure, the number of uplink transmission failures are counted with assistance of a timer.

According to a second aspect of the disclosure, there is provided a method in a network node. The method comprises receiving a scheduling request, SR from a terminal device, wherein the SR is to request an uplink grant, and the SR is triggered by the terminal device upon a preconfigured number of uplink transmission failures when using configured grants. The method further comprises transmitting an uplink grant to the terminal device.

In an embodiment of the disclosure, the method further comprises receiving at least part of the uplink transmission with respective configured grant from the terminal device.

In an embodiment of the disclosure, the uplink transmission failures comprise at least one of: a listen before talk, LBT, failure; a negative acknowledgement is received after an uplink transmission; neither positive nor negative acknowledgement is received after an uplink transmission; expiration of a configured grant timer associated with the uplink transmission; and expiration of a configured grant retransmission timer associated with the uplink transmission.

In an embodiment of the disclosure, the preconfigured number of uplink transmission failures comprises consecutive or non-consecutive uplink transmission failures.

In an embodiment of the disclosure, the uplink transmission is received with a hybrid automatic repeat request, HARQ, process, the negative acknowledgement is a HARQ NACK, and the positive acknowledgement is a HARQ ACK.

In an embodiment of the disclosure, the SR is triggered per SR configuration, and the SR configuration is associated with at least one of: LBT channel, LBT sub-band, bandwidth part, BWP, cell, carrier, cell group, service, Logic Channel, LCH, and Logical Channel Group, LCG.

In an embodiment of the disclosure, the method further comprises receiving a report indicating a SR triggering cause from the terminal device.

In an embodiment of the disclosure, the SR is received via a Physical Uplink Control Channel, PUCCH, or a Random Access Channel, RACH, procedure from the terminal device.

In an embodiment of the disclosure, the method further comprises transmitting at least one updated configured grant to the terminal device.

In an embodiment of the disclosure, the at least one updated configure grant is per LBT channel, LBT sub-band, BWP, cell, or carrier.

In an embodiment of the disclosure, the number of uplink transmission failures are counted with assistance of a timer.

According to a third aspect of the disclosure, there is provided a terminal device. The terminal device comprises at least one processor and at least one memory. The at least one memory contains instructions executable by the at least one processor, whereby the terminal device is operative to trigger a scheduling request, SR, to request an uplink grant upon a preconfigured number of uplink transmission failures when using configured grants. The terminal device is further operative to transmit the SR to a network node.

In an embodiment of the disclosure, the terminal device is operative to perform the method according to the above first aspect.

According to a fourth aspect of the disclosure, there is provided a network node. The network node comprises at least one processor and at least one memory. The at least one memory contains instructions executable by the at least one processor, whereby the network node is operative to receive a scheduling request, SR from a terminal device, wherein the SR is to request an uplink grant, and the SR is triggered by the terminal device upon a preconfigured number of uplink transmission failures when using configured grants. The network node is further operative to transmit an uplink grant to the terminal device.

In an embodiment of the disclosure, the network node is operative to perform the method according to the above second aspect.

According to a fifth aspect of the disclosure, there is provided a computer program product. The computer program product comprises instructions which when executed by at least one processor, cause the at least one processor to perform the method according to any of the above first and second aspects.

According to a sixth aspect of the disclosure, there is provided a computer readable storage medium. The computer readable storage medium comprises instructions which when executed by at least one processor, cause the at least one processor to perform the method according to any of the above first and second aspects.

According to a seventh aspect of the disclosure, there is provided a terminal device. The terminal device comprises a triggering module for trigger a scheduling request, SR, to request an uplink grant upon a preconfigured number of uplink transmission failures when using configured grants. The terminal device further comprises a transmitting module for transmitting the SR to a network node.

According to an eighth aspect of the disclosure, there is provided a network node. The network node comprises a receiving module for receiving a scheduling request, SR from a terminal device, wherein the SR is to request an uplink grant, and the SR is triggered by the terminal device upon a preconfigured number of uplink transmission failures when using configured grants. The network node further comprises a transmitting module for transmitting an uplink grant to the terminal device.

According to a ninth aspect of the disclosure, there is provided a method implemented in a communication system including a host computer, a base station and a terminal device. The method comprises, at the host computer, receiving user data transmitted to the base station from the terminal device. The terminal device transmits a TB to the base station with a first configured grant. The terminal device retransmits the TB to the base station autonomously with a second configured grant.

In an embodiment of the disclosure, the method further comprises, at the terminal device, providing the user data to the base station.

In an embodiment of the disclosure, the method further comprises, at the terminal device, executing a client application, thereby providing the user data to be transmitted. The method further comprises, at the host computer, executing a host application associated with the client application.

In an embodiment of the disclosure, the method further comprises, at the terminal device, executing a client application. The method further comprises, at the terminal device, receiving input data to the client application. The input data is provided at the host computer by executing a host application associated with the client application. The user data to be transmitted is provided by the client application in response to the input data.

According to a tenth aspect of the disclosure, there is provided a communication system including a host computer comprising a communication interface configured to receive user data originating from a transmission from a terminal device to a base station. The terminal device comprises a radio interface and processing circuitry. The processing circuitry of the terminal device is configured to transmit a TB to the base station with a first configured grant. The processing circuitry of the terminal device is further configured to retransmit the TB to the base station autonomously with a second configured grant.

In an embodiment of the disclosure, the communication system further includes the terminal device.

In an embodiment of the disclosure, the communication system further includes the base station. The base station comprises a radio interface configured to communicate with the terminal device and a communication interface configured to forward to the host computer the user data carried by a transmission from the terminal device to the base station.

In an embodiment of the disclosure, the processing circuitry of the host computer is configured to execute a host application. The processing circuitry of the terminal device is configured to execute a client application associated with the host application, thereby providing the user data.

In an embodiment of the disclosure, the processing circuitry of the host computer is configured to execute a host application, thereby providing request data. The processing circuitry of the terminal device is configured to execute a client application associated with the host application, thereby providing the user data in response to the request data.

According to an eleventh aspect of the disclosure, there is provided a method implemented in a communication system including a host computer, a base station and a terminal device. The method comprises, at the host computer, receiving, from the base station, user data originating from a transmission which the base station has received from the terminal device. The base station receives, from a terminal device, information related to one or more autonomous uplink retransmissions of a TB with one or more configured grants. The base station determines a scheduling policy or a scheduling decision for the TB based on the information.

In an embodiment of the disclosure, the method further comprises, at the base station, receiving the user data from the terminal device.

In an embodiment of the disclosure, the method further comprises, at the base station, initiating a transmission of the received user data to the host computer.

According to a twelfth aspect of the disclosure, there is provided a communication system including a host computer comprising a communication interface configured to receive user data originating from a transmission from a terminal device to a base station. The base station comprises a radio interface and processing circuitry. The base station's processing circuitry is configured to receive, from a terminal device, information related to one or more autonomous uplink retransmissions of a TB with one or more configured grants. The base station's processing circuitry is further configured to determine a scheduling policy or a scheduling decision for the TB based on the information.

In an embodiment of the disclosure, the communication system further includes the base station.

In an embodiment of the disclosure, the communication system further includes the terminal device. The terminal device is configured to communicate with the base station.

In an embodiment of the disclosure, the processing circuitry of the host computer is configured to execute a host application. The terminal device is configured to execute a client application associated with the host application, thereby providing the user data to be received by the host computer.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a flowchart illustrating a method implemented at a terminal device according to some embodiments of the disclosure;

FIG. 2 is a flowchart illustrating a method implemented at a network node according to some embodiments of the disclosure;

FIG. 3 is a block diagram showing a terminal device according to some embodiments of the disclosure;

FIG. 4 is a block diagram showing a network node according to some embodiments of the disclosure;

FIG. 5 is a block diagram showing a terminal device according to some embodiments of the disclosure;

FIG. 6 is a block diagram showing a network node according to some embodiments of the disclosure;

FIG. 7 is a diagram showing a telecommunication network connected via an intermediate network to a host computer in accordance with some embodiments;

FIG. 8 is a diagram showing a host computer communicating via a base station with a user equipment in accordance with some embodiments;

FIG. 9 is a flowchart illustrating a method implemented in a communication system in accordance with some embodiments;

FIG. 10 is a flowchart illustrating a method implemented in a communication system in accordance with some embodiments;

FIG. 11 is a flowchart illustrating a method implemented in a communication system in accordance with some embodiments; and

FIG. 12 is a flowchart illustrating a method implemented in a communication system in accordance with some embodiments.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

In NR-U, both configured scheduling and dynamic scheduling will be used. Configured scheduling is used to allocate semi-static periodic assignments or grants for a UE. For uplink, there are two types of configured scheduling schemes: Type 1 and Type 2. For Type 1, configured grants are configured via radio resource control (RRC) signaling only. For Type 2, similar configuration procedure as semi-persistent scheduling (SPS) uplink (UL) in long term evolution (LTE) was defined, i.e. some parameters are preconfigured via RRC signaling and some physical layer parameters are configured via media access control (MAC) scheduling procedure. The detailed procedures can be found in 3GPP technical specification (TS) 38.321 V15.4.0. The configured uplink scheduling will be also used in NR unlicensed operation. For NR-U, the configured scheduling can improve the channel access probability for physical uplink shared channel (PUSCH) transmission because additional LBT for physical downlink control channel (PDCCH) transmission per UL grant is avoided and the UE can acquire channel for PUSCH transmission using a configured grant after LBT success. In this uplink transmission procedure, only single LBT procedure is needed compared to 3 LBT procedures (one for scheduling request (SR) transmission (TX), one for PDCCH for UL grant and one for PUSCH TX) relying on SR/buffer status report (BSR) procedure. This can significantly improve the channel access probability for PUSCH transmission. For dynamic scheduling, a UE transmits PUSCH using an immediate UL grant which is indicated by the gNB using a PDCCH addressed to C-RNTI.

When there is data transmission requirement in the uplink and there is not UL grant available for a UE, the UE can send an scheduling request (SR) to the serving gNB in the uplink. In response to the SR reception, the serving gNB can send an UL grant to the UE. With the received UL grant, the UE can send BSR and the data in the uplink.

In 3GPP NR Rel-15, the SR resources (i.e. SR configuration) can be configured per Logic Channel (LCH), i.e. different LCHs may be configured with different SR configurations. Based on different SR resources, the gNB can differentiate the LCHs requesting the UL grant and determine the UL scheduling with the scheduling priority of the LCH into account.

As captured in the 3GPP technical report (TR) 38.889 V16.0.0, allowing consecutive configured grant resources in time without any gaps in between the resources and non-consecutive configured grant resources (not necessarily periodic) with gaps in between the resources is beneficial.

For NR-U, certain enhancement of configured scheduling is referred to as autonomous uplink (AUL) transmission. For instance, when the initial transmission using a configured grant is determined to be failed by a UE, the UE can perform automatic retransmission using another configured grant.

To support autonomous retransmission in uplink using a configured grant, a new timer, which is called configured grant (CG) retransmission timer, was introduced to protect the HARQ procedure so that the retransmission can use the same HARQ process for retransmission as for the initial transmission. The new timer (“CG retransmission timer”) is introduced for auto retransmission (i.e. timer expiry=HARQ NACK) on configured grant for the case of the transport block (TB) previously being transmitted on a configured grant. The new timer is started when the TB is actually transmitted on the configured grant and stopped upon reception of HARQ feedback (e.g. dynamic feedback indicator (DFI)) or dynamic grant for the HARQ process. The legacy configured grant timer and behavior is kept for preventing the configured grant overriding the TB scheduled by dynamic grant, i.e. it is (re)started upon reception of the PDCCH as well as transmission on the PUSCH of dynamic grant.

Therefore, a CG retransmission timer is started for a HARQ process configured with autonomous uplink (AUL) transmission upon the data transmission using a configured grant, and autonomous retransmission using another configured grant is triggered when the CG retransmission timer expires.

However, the transmission using a configured grant may fail in any of the following cases:
The UE fails to access the channel due to LBT failure;
The UE transmits the data but the serving gNB fails to decode the data.

The data may not be able to reach the serving gNB when there are consecutive LBT failures or HARQ transmission/retransmission failures for a UE. If one or multiple UEs autonomous triggered transmission or retransmissions with a configured grant, but the transmission or retransmissions are not received by the gNB, the gNB would then have no possibility to schedule retransmissions to this UE. In such cases, the UE may have to rely on upper layer retransmissions, however, it may take some time to trigger upper layer retransmissions since upper layer retransmissions are typically triggered by expiration of the retransmission timer. For latency critical services, such latency may be not acceptable. Hence, the UE behavior in these conditions should be improved.

The present disclosure proposes an improved solution for uplink transmission. The solution may be applied to a wireless communication system including a terminal device such as a UE and a network node such as a base station or any other node with similar functionality. The terminal device can communicate through a radio access communication link with the base station. The base station can provide radio access communication links to terminal devices that are within its communication service cell. Note that the communications may be performed between the terminal device and the base station according to any suitable communication standards and protocols. The terminal device may also be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

Now, several embodiments will be described to explain the improved solution for uplink transmission. Although these embodiments will be described in the context of NR-U, the principle of the disclosure is also applicable to other unlicensed operation scenarios (e.g. LTE LAA/eLAA/feLAA/MuLteFire) and licensed operation scenarios where autonomous uplink retransmission using configured grant may be adopted. The term LAA refers to licensed assisted access, the term eLAA refers to enhanced LAA and the term feLAA refers to further enhanced LAA.

As a first embodiment, when a UE experiences consecutive failures for autonomously triggered transmissions in a serving LBT channel/LBT sub-band/BWP/carrier/cell, a scheduling request (SR) can be triggered if SR resource is available. The SR resource may comprises physical downlink control channel (PDCCH), etc. There are several cases described as below.

Case 1, an SR is triggered upon occurrence of consecutive LBT failures.

In this example, if the UE has experienced consecutively occurred LBT failures for uplink (UL) transmissions using configured grants associated with a HARQ process for a configured number of times, and there is no dynamic UL grant available for transmission, an SR can be triggered and optionally transmitted in another LBT channel/LBT sub-band/BWP/carrier/cell to request dynamic UL grants. However, while the SR is pending, as soon as at least LBT succeeds for data transmission using configured grant in the current serving LBT channel/LBT sub-band/BWP/carrier/cell, the pending SR may be cancelled.

Case 2, an SR is triggered when there is no HARQ feedback received for a HARQ process after a configured number of consecutive autonomous UL transmissions using configured grants. In another example, there is only HARQ NACKs received for this HARQ process, however, no any dynamic grant received for retransmission for this HARQ process after a configured number of consecutive autonomous UL transmissions using configured grants.

In this case, there is high failure probability for the UE to continually perform autonomous retransmissions using the same configured grants. If this case occurs in the current serving LBT channel/LBT sub-band/BWP/carrier/cell for transmission, an SR can be triggered and optionally transmitted in another LBT channel/LBT sub-band/BWP/carrier/cell to request dynamic UL grants in that LBT channel/LBT sub-band/BWP/carrier/cell. This case may happen due to poor link adaptation performance for UL data transmission using configured grants or deafness occurrence (i.e. the gNB receivers suffers large interference while the UE does not hear the interference). While the SR is pending, when at least a HARQ ACK is received from the serving gNB for the HARQ process, the SR may be cancelled.

Case 3, an SR is triggered when the configured grant timer (configuredGrantTimer) expires, while the UE has failed to receive any HARQ ACK for a HARQ process that the UE has performed autonomous transmissions using configured grants for the HARQ process. In the existing 3GPP specification, when expiration of the configuredGrantTimer occurs, the UE assumes ACK for the corresponding HARQ process. However, in this case, this assumption doesn't make sense. Therefore, the UE shall assume NACK for the corresponding HARQ process in this case. The UE can immediately trigger upper layer retransmission, at the same time, an SR can be triggered to request dynamic grants for retransmission of the corresponding data.

In an embodiment, the number of uplink transmission failures may be counted with the assistance of a timer. The timer is started upon an uplink transmission failure and the number of uplink transmission failure, which may be counted by a counter, is set to 1. During the timer running, the number of uplink transmission failures (e.g. the value of the counter) is increased by 1 when an uplink transmission failure is determined. If the number of uplink transmission failure (e.g. the value of the counter) reaches or exceeds the preconfigured number of uplink transmission failures when the timer expires, the SR request is triggered. Meanwhile, the timer is stopped, and the number of uplink transmission failures (e.g. the value of the counter) is reset to zero. Otherwise, if the number of uplink transmission failure (e.g. the value of the counter) is below the preconfigured number of uplink transmission failures when the timer expires, the number of uplink transmission failures (e.g. the value of the counter) is reset to zero.

In a second embodiment, if no SR resource is configured for SR transmission when any of the above cases occurs, a RACH procedure may be triggered to request UL grants.

In a third embodiment, the new SR triggering condition as defined in the first embodiment can be configured per SR configuration, per LBT channel/LBT sub-band/BWP/cell/carrier/cell group using RRC signaling. The new SR triggering condition may be also configured per service/LCH/LCG. In one example, it is only services with critical latency requirement that is allowed to trigger an SR upon occurrence of any case that is described in the first embodiment.

In a fourth embodiment, when multiple CG grants in different sub-bands in the same carrier are available, the UE can choose a different CG grant in a different sub-band for autonomous retransmission when no HARQ feedback is received for the previous transmission. If the MAC PDU of a failed transmission using a first configured grant in one sub-band (or sub-band set) does not fit capacity provided by a second configured grant in another sub-band (or sub-band set), the UE can unpack the MAC PDU and repack the data into the new MAC PDU for transmission on the second sub-band.

In a fifth embodiment, when an SR based on any of the above embodiment is triggered and UL grants are received after SR transmission, the UE reports the SR triggering cause to the serving gNB. Upon reception of the SR triggering cause, the serving gNB may choose to reconfigure the configured grants to a different LBT channel/LBT sub-band/BWP/cell/carrier which has better channel availability status.

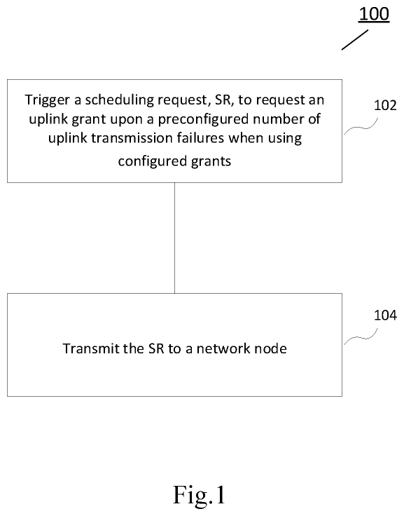

Hereinafter, the solution will be further described with reference to FIGS. 1-12.

FIG. 1 is a flowchart illustrating a method implemented at a terminal device according to some embodiments of the disclosure. The terminal device may be a user equipment (UE) or any other devices with similar functionality. At block 102, the terminal device triggers a scheduling request (SR) to request an uplink grant upon a preconfigured number of uplink transmission failures when using configured grants. The uplink grant may be one or more dynamic uplink grants or configured grants for scheduling the uplink transmission. The configured grants may be a series of another configured grants or updated configured grants. The network node may be a base station or any other node with similar functionality. At block 104, the terminal device transmits the SR to a network node. In accordance with an exemplary embodiment, the preconfigured number of uplink transmission failures comprise consecutive or non-consecutive uplink transmission failures. In accordance with an exemplary embodiment, the terminal device may further receive an uplink grant from the network node, and the uplink grant may be addressed to Cell Radio Network Tempory Identity (C-RNTI).

In accordance with an exemplary embodiment, the terminal device may cancel a pending SR when at least one LBT process successes or when at least one positive acknowledgement for the uplink transmission is received. In accordance with an exemplary embodiment, the uplink transmission is performed with a hybrid automatic repeat request (HARQ) process. In accordance with an exemplary embodiment, the uplink transmission failures comprise at least one of the following cases.

Case 1—a listen before talk (LBT) failure. The LBT failure may comprise one or multiple LBT failures, and the multiple LBT failures may be consecutive or non-consecutive LBT failures. In this example, if the UE has experienced consecutively occurred LBT failures for UL transmissions using configured grants associated with a HARQ process for a configured number of times, and there is no dynamic UL grant available for transmission, an SR can be triggered (and optionally transmitted in another LBT channel/LBT sub-band/BWP/carrier/cell) to request dynamic UL grants. However, while the SR is pending, as soon as at least LBT succeeds for data transmission using configured grant in the current serving LBT channel/LBT sub-band/BWP/carrier/cell the pending SR is cancelled.

Case 2—a negative acknowledgement is received after an uplink transmission, or neither positive nor negative acknowledgement is received after an uplink transmission. In an example, there is no HARQ feedback received for a HARQ process after a configured number of consecutive autonomous UL transmissions using configured grants. In another example, there is only HARQ NACKs received for this HARQ process. However, no dynamic grant received for retransmission for this HARQ process after a configured number of consecutive autonomous UL transmissions using configured grants. In this case, there is high failure probability for the UE to continually perform autonomous retransmissions using the same configured grants. If this case occurs in the current serving LBT channel/LBT sub-band/BWP/carrier/cell for transmission, an SR can be triggered and transmitted in another LBT channel/LBT sub-band/BWP/carrier/cell to request dynamic UL grants in that LBT channel/LBT sub-band/BWP/carrier/cell. This case may happen due to poor link adaptation performance for UL data transmission using configured grants or deafness occurrence (i.e. the gNB receivers suffers large interference while the UE does not hear the interference). While the SR is pending, when at least a HARQ ACK is received from the serving gNB for the HARQ process, the SR is cancelled.

Case 3—expiration of a configured grant timer associated with the uplink transmission; or expiration of a configured grant retransmission timer associated with the uplink transmission. In an example, configuredGrantTimer expires while the UE has failed to receive any HARQ ACK for a HARQ process that the UE has performed autonomous transmissions using configured grants for the HARQ process. In the prior arts, when the configuredGrantTimer expires, the UE assumes ACK for the corresponding HARQ process. However, in this case, this assumption doesn't make sense. Therefore, the UE shall assume NACK for the corresponding HARQ process in this case. The UE can immediately trigger upper layer retransmission, at the same time, an SR can be triggered to request dynamic grants for retransmission of the corresponding data.

In accordance with an exemplary embodiment, the negative acknowledgement is a HARQ NACK, and the positive acknowledgement is a HARQ ACK.

In accordance with an exemplary embodiment, the SR is triggered per SR configuration, and the SR configuration is associated with at least one of: LBT channel, LBT sub-band, bandwidth part, BWP, cell, carrier, cell group, service, Logic Channel, LCH, and Logical Channel Group, LCG. In other words, the new SR triggering condition as defined in the above embodiment can be configured per SR configuration, per LB T channel/LBT sub-band/BWP/cell/carrier/cell group using RRC signaling. The new SR triggering condition may be also configured per service/LCH/LCG. In one example, it is only services with critical latency requirement this is allowed to trigger an SR upon occurrence of any case this is described in the first embodiment.

In accordance with an exemplary embodiment, the terminal device may further transmit a report indicating a SR triggering cause to the network node. In accordance with an exemplary embodiment, the terminal device may further receive at least one updated configured grant from the network node. In accordance with an exemplary embodiment, the at least one updated configure grant is per LBT channel, LBT sub-band, BWP, cell, or carrier. When an SR is triggered and UL grants are received after SR transmission, the UE reports the SR triggering cause to the serving gNB. Upon reception of the SR triggering cause, the serving gNB may choose to reconfigure the configured grants to a different LBT channel/LBT sub-band/BWP/cell/carrier which has better channel availability status.

In accordance with an exemplary embodiment, the SR is transmitted via a Physical Uplink Control Channel (PUCCH) or a Random Access Channel (RACH) procedure to the network node. If no SR resource (PUCCH) is configured for SR transmission, a RACH procedure may be triggered to request UL grants.

In accordance with an exemplary embodiment, the number of uplink transmission failures are counted with assistance of a timer. In an embodiment, the number of uplink transmission failures may be counted with the assistance of a timer. The timer is started upon an uplink transmission failure and the number of uplink transmission failure, which may be counted by a counter, is set to 1. During the timer running, the number of uplink transmission failures (e.g. the value of the counter) is increased by 1 when an uplink transmission failure is determined. If the number of uplink transmission failure (e.g. the value of the counter) reaches or exceeds the preconfigured number of uplink transmission failures when the timer expires, the SR request is triggered. Meanwhile, the timer is stopped, and the number of uplink transmission failures (e.g. the value of the counter) is reset to zero. Otherwise, if the number of uplink transmission failure (e.g. the value of the counter) is below the preconfigured number of uplink transmission failures when the timer expires, the number of uplink transmission failures (e.g. the value of the counter) is reset to zero.

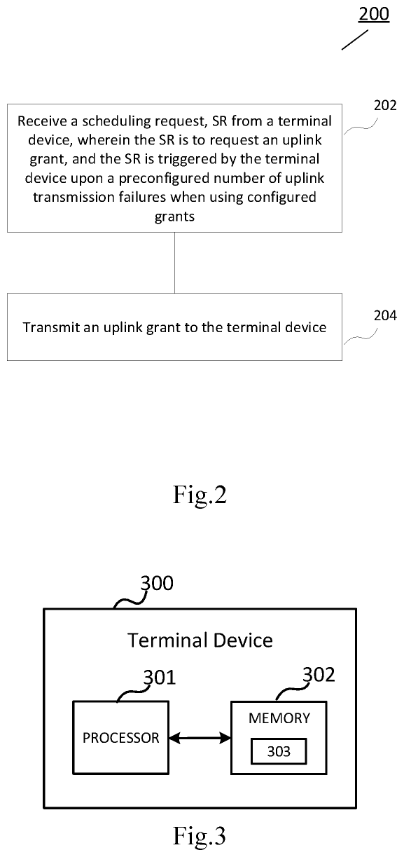

FIG. 2 is a flowchart illustrating a method implemented at a network node according to some embodiments of the disclosure. The network node may be a base station or any other node with similar functionality. At block 202, the network node receives a scheduling request (SR) from a terminal device, wherein the SR is to request an uplink grant, and the SR is triggered by the terminal device upon a preconfigured number of uplink transmission failures when using configured grants. The uplink grant may be one or more dynamic uplink grants or configured grants for scheduling the uplink transmission. The configured grants may be a series of another configured grants or updated configured grants. At block 204, the network node may further transmit an uplink grant to the terminal device. The uplink grant may be addressed to Cell Radio Network Tempory Identity (C-RNTI). In accordance with an exemplary embodiment, the preconfigured number of uplink transmission failures comprise consecutive or non-consecutive uplink transmission failures. In accordance with an exemplary embodiment, the network node may further receive at least part of the uplink transmission with respective configured grant prior to the SR reception from the terminal device, and some other part of the uplink transmission may not successfully reach the network node, such as not transmitted by the terminal device, or transmitted but not reached the network node with some causes. In accordance with an exemplary embodiment, the uplink transmission is received with a hybrid automatic repeat request (HARQ) process.

In accordance with an exemplary embodiment, the uplink transmission failures comprise at least one of the following cases.

Case 1—a listen before talk (LBT) failure. The LBT failure may comprise one or multiple LBT failures, and the multiple LBT failures may be consecutive or non-consecutive LBT failures. In this example, if the UE has experienced consecutively occurred LBT failures for UL transmissions using configured grants associated with a HARQ process for a configured number of times, and there is no dynamic UL grant available for transmission, an SR can be triggered (and optionally transmitted in another LBT channel/LBT sub-band/BWP/carrier/cell) to request dynamic UL grants.

Case 2—a negative acknowledgement is received after an uplink transmission, or neither positive nor negative acknowledgement is received after an uplink transmission. In an example, there is no HARQ feedback received for a HARQ process after a configured number of consecutive autonomous UL transmissions using configured grants. In another example, there is only HARQ NACKs received for this HARQ process. However, no dynamic grant received for retransmission for this HARQ process after a configured number of consecutive autonomous UL transmissions using configured grants. In this case, there is high failure probability for the UE to continually perform autonomous retransmissions using the same configured grants. If this case occurs in the current serving LBT channel/LBT sub-band/BWP/carrier/cell for transmission, an SR can be triggered and transmitted in another LBT channel/LBT sub-band/BWP/carrier/cell to request dynamic UL grants in that LBT channel/LBT sub-band/BWP/carrier/cell. This case may happen due to poor link adaptation performance for UL data transmission using configured grants or deafness occurrence (i.e. the gNB receivers suffers large interference while the UE does not hear the interference).

Case 3—expiration of a configured grant timer associated with the uplink transmission; or expiration of a configured grant retransmission timer associated with the uplink transmission. In an example, configuredGrantTimer expires while the UE has failed to receive any HARQ ACK for a HARQ process that the UE has performed autonomous transmissions using configured grants for the HARQ process. In the prior arts, when the configuredGrantTimer expires, the UE assumes ACK for the corresponding HARQ process. However, in this case, this assumption doesn't make sense. Therefore, the UE shall assume NACK for the corresponding HARQ process in this case. The UE can immediately trigger upper layer retransmission, at the same time, an SR can be triggered to request dynamic grants for retransmission of the corresponding data.

In accordance with an exemplary embodiment, the negative acknowledgement is a HARQ NACK, and the positive acknowledgement is a HARQ ACK.

In accordance with an exemplary embodiment, the SR is triggered per SR configuration, and the SR configuration is associated with at least one of: LBT channel, LBT sub-band, bandwidth part, BWP, cell, carrier, cell group, service, Logic Channel, LCH, and Logical Channel Group, LCG. In other words, the new SR triggering condition as defined in the above embodiment can be configured per SR configuration, per LB T channel/LBT sub-band/BWP/cell/carrier/cell group using RRC signaling. The new SR triggering condition may be also configured per service/LCH/LCG. In one example, it is only services with critical latency requirement this is allowed to trigger an SR upon occurrence of any case this is described in the first embodiment.

In accordance with an exemplary embodiment, the network node may further receive a report indicating a SR triggering cause to the network node. In accordance with an exemplary embodiment, the network node may further transmit at least one updated configured grant to the terminal device. In accordance with an exemplary embodiment, wherein the at least one updated configure grant is per LBT channel, LBT sub-band, BWP, cell, or carrier. When an SR is triggered and UL grants are received after SR transmission, the UE reports the SR triggering cause to the serving gNB. Upon reception of the SR triggering cause, the serving gNB may choose to reconfigure the configured grants to a different LBT channel/LBT sub-band/BWP/cell/carrier which has better channel availability status.

In accordance with an exemplary embodiment, the SR is received via a Physical Uplink Control Channel (PUCCH) or a Random Access Channel (RACH) procedure to the network node. If no SR resource (PUCCH) is configured for SR transmission, a RACH procedure may be triggered to request UL grants.

In accordance with an exemplary embodiment, the number of uplink transmission failures are counted with assistance of a timer. In an embodiment, the number of uplink transmission failures may be counted with the assistance of a timer. The timer is started upon an uplink transmission failure and the number of uplink transmission failure, which may be counted by a counter, is set to 1. During the timer running, the number of uplink transmission failures (e.g. the value of the counter) is increased by 1 when an uplink transmission failure is determined. If the number of uplink transmission failure (e.g. the value of the counter) reaches or exceeds the preconfigured number of uplink transmission failures when the timer expires, the SR request is triggered. Meanwhile, the timer is stopped, and the number of uplink transmission failures (e.g. the value of the counter) is reset to zero. Otherwise, if the number of uplink transmission failure (e.g. the value of the counter) is below the preconfigured number of uplink transmission failures when the timer expires, the number of uplink transmission failures (e.g. the value of the counter) is reset to zero.

With such solutions, a terminal device such as a UE can trigger a SR to request for a UL grant upon multiple UL transmission failures, so the network node such as a base station can allocate uplink grant for this UE. When the UL grant is received, the UE uses this UL grant for UL transmission. In such cases, the newly received UL grant can be used before using an early received UL grant. Besides that, when it is used in the AUL, a good adaptability of AUL configuration can be achieved. With this scheme, the configured grant of AUL scheduling can be better adapted in response to radio condition change such as interference and pathloss variation, and the configurations support flexible mapping of logical channels to AUL transmissions.

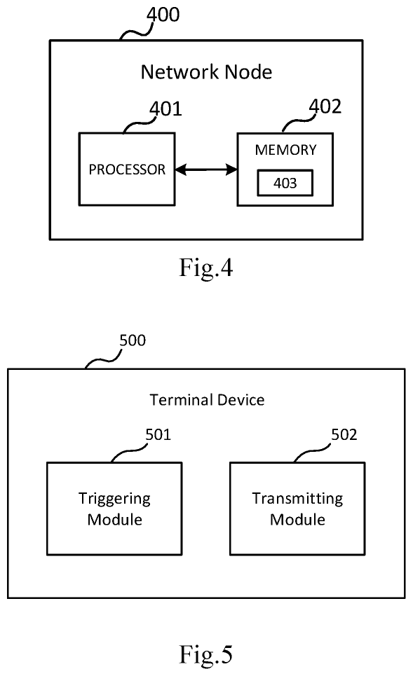

FIG. 3 and FIG. 4 are block diagrams illustrating an apparatus 300 and 400 according to various embodiments of the present disclosure, such as a terminal device and a network node respectively. As shown in FIG. 3 and FIG. 4, the apparatus 300 and 400 may comprise one or more processors such as processor 301 and 401, and one or more memories such as memory 302 and 402, storing computer program codes 303 and 403. The memory 302 and 402 may be non-transitory machine/processor/computer readable storage medium. In accordance with some exemplary embodiments, the apparatus 300 and 400 may be implemented as an integrated circuit chip or module that can be plugged or installed into a terminal device as described with respect to FIG. 1, and a network node as described with respect to FIG. 2. That is, the embodiments of the present disclosure may be implemented at least in part by computer software executable by the processor 301 or 401, or by hardware, or by a combination of software and hardware.

The memory 302 and 402 may be of any type suitable to the local technical environment and may be implemented using any suitable data storage technology, such as semiconductor based memory devices, flash memories, magnetic memory devices and systems, optical memory devices and systems, fixed memories and removable memories. The processor 301 or 401 may be of any type suitable to the local technical environment, and may include one or more of general purpose computers, special purpose computers, microprocessors, digital signal processors (DSPs) and processors based on multi-core processor architectures, as non-limiting examples.

FIG. 5 is a block diagram illustrating a terminal device 500 according to some embodiments of the present disclosure. As shown in FIG. 5, the terminal device 500 may comprise a triggering module 501 and a transmitting module 502. The triggering module 501 may be operable to carry out the operation in block 102, and the transmitting module 502 may be operable to carry out the operation in block 104. Optionally, the triggering module 501 and/or the transmitting module 502 may be operable to carry out more or less operations to implement the proposed methods according to the exemplary embodiments of the present disclosure.

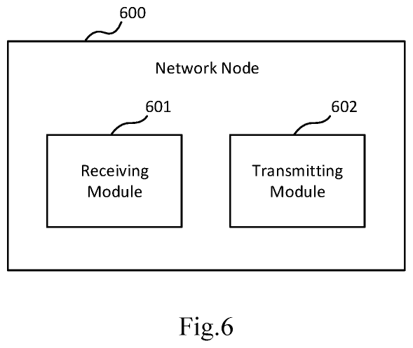

FIG. 6 is a block diagram illustrating an network device 600 according to some embodiments of the present disclosure. As shown in FIG. 6, the network device 600 may comprise a receiving module 601 and a transmitting module 602. The receiving module 601 may be operable to carry out the operation in block 202, and the transmitting module 602 may be operable to carry out the operation in block 204. Optionally, receiving module 601 and/or the transmitting module 602 may be operable to carry out more or less operations to implement the proposed methods according to the exemplary embodiments of the present disclosure.

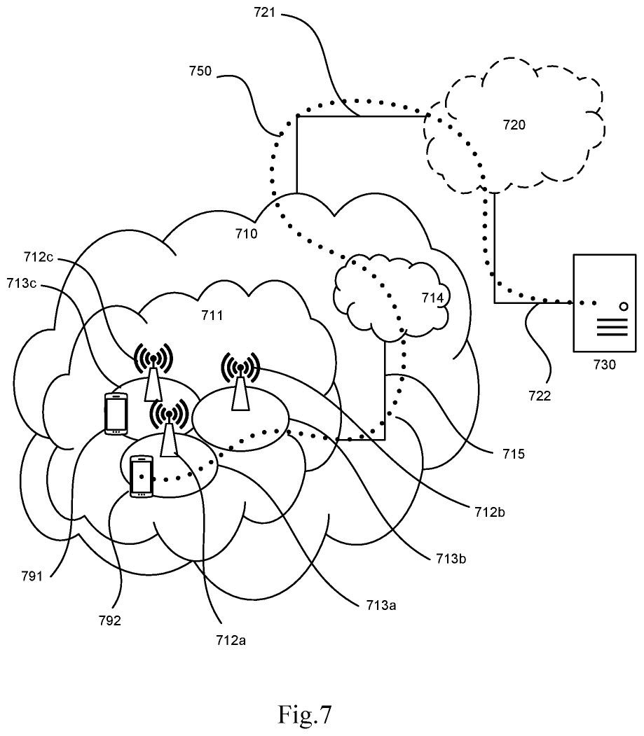

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

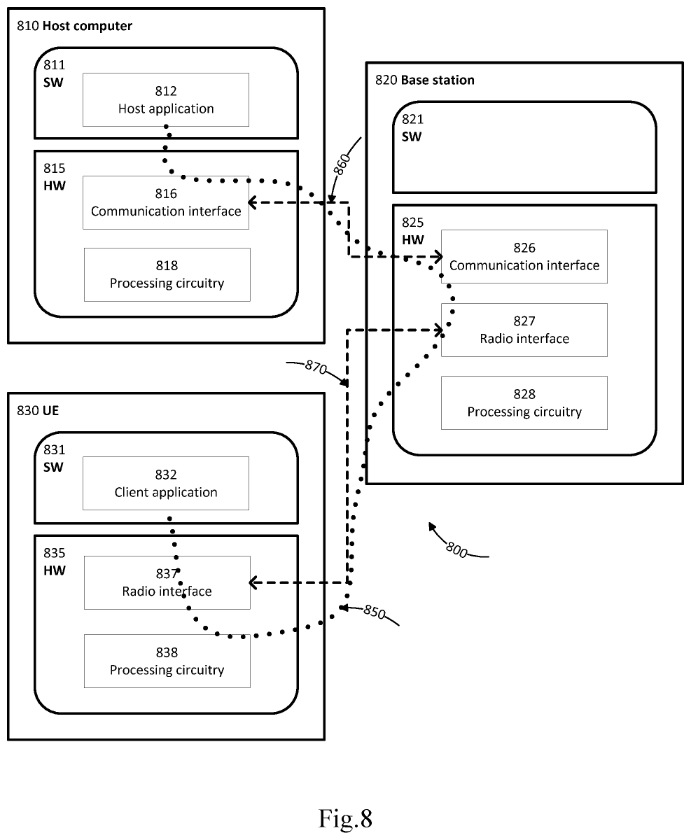

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

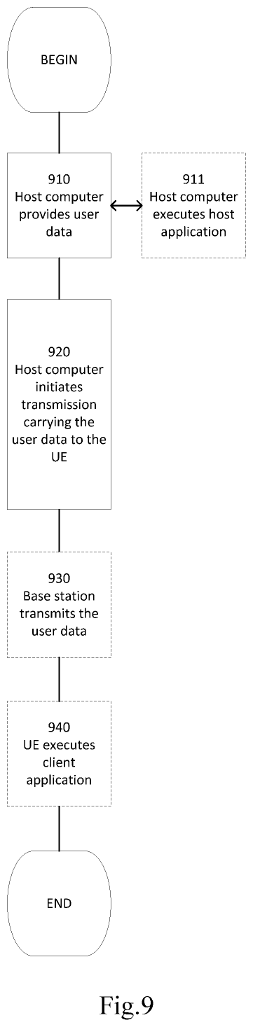

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

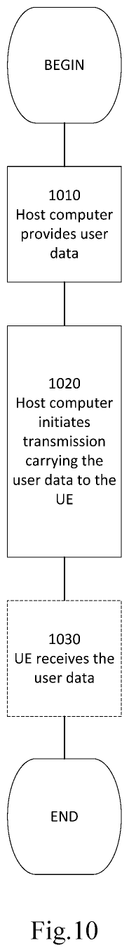

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

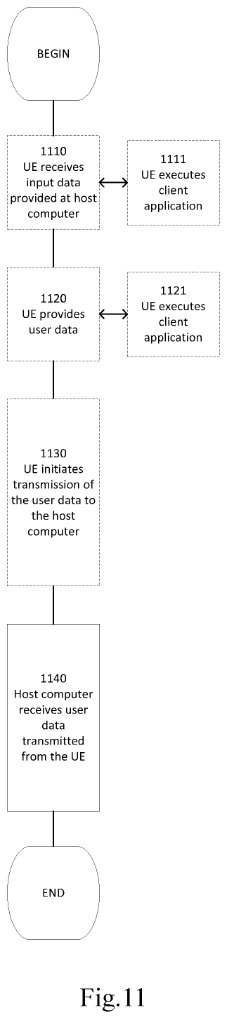

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

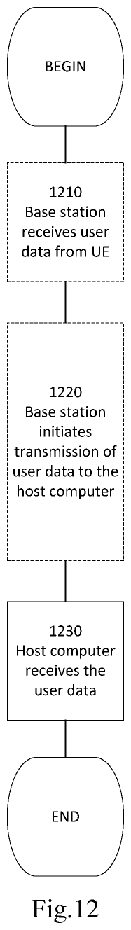

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1-28. (canceled)

29. A method in a terminal device, the method comprising the terminal device:
triggering a scheduling request (SR) to request an uplink grant upon a preconfigured number of uplink transmission failures when using configured grants; and
transmitting the SR to a network node.

30. The method of claim 29, wherein the uplink transmission failures comprise:
a Listen Before Talk (LBT) failure;
a negative acknowledgement received after an uplink transmission;
neither positive nor negative acknowledgement is received after an uplink transmission;
expiration of a configured grant timer associated with the uplink transmission; and/or
expiration of a configured grant retransmission timer associated with the uplink transmission.

31. The method of claim 29, wherein the preconfigured number of uplink transmission failures comprise consecutive uplink transmission failures.

32. The method of claim 30, wherein the uplink transmission is performed with a hybrid automatic repeat request (HARQ) process, the negative acknowledgement is a HARQ NACK, and the positive acknowledgement is a HARQ ACK.

33. The method of claim 29:
wherein the SR is triggered per SR configuration; and
wherein the SR configuration is associated with: Listen Before Talk (LBT) channel, LBT sub-band, bandwidth part (BWP), cell, carrier, cell group, service, Logic Channel (LCH), and/or Logical Channel Group (LCG).

34. The method of claim 29, further comprising transmitting a report indicating a SR triggering cause to the network node.

35. The method, further comprising:
cancelling a pending SR when at least one Listen Before Talk (LBT) process successes; or
cancelling a pending SR when at least one positive acknowledgement for the uplink transmission is received.

36. The method of claim 29, wherein the SR is transmitted via a Physical Uplink Control Channel (PUCCH) or a Random Access Channel (RACH) procedure to the network node.

37. The method of claim 29, further comprising receiving at least one updated configured grant from the network node.

38. The method of claim 37, wherein the at least one updated configure grant is per Listen Before Talk (LBT) channel, LBT sub-band, bandwidth part (BWP), cell, or carrier.

39. The method of claim 29, further comprising receiving an uplink grant from the network node.

40. The method of claim 29, wherein the number of uplink transmission failures are counted with assistance of a timer.

41. A method in a network node, the method comprising the network node:
receiving a scheduling request (SR) from a terminal device, wherein the SR is to request an uplink grant, and wherein the SR is triggered by the terminal device upon a preconfigured number of uplink transmission failures when using configured grants; and
transmitting an uplink grant to the terminal device.

42. The method of claim 41, further comprising receiving at least part of the uplink transmission with respective configured grant from the terminal device.

43. The method of claim 41, wherein the uplink transmission failures comprise:
a Listen Before Talk (LBT) failure;
a negative acknowledgement is received after an uplink transmission;
neither positive nor negative acknowledgement is received after an uplink transmission;
expiration of a configured grant timer associated with the uplink transmission; and/or
expiration of a configured grant retransmission timer associated with the uplink transmission.

44. The method of claim 41, wherein the preconfigured number of uplink transmission failures comprise consecutive uplink transmission failures.

45. The method of claim 41:
wherein the SR is triggered per SR configuration; and
wherein the SR configuration is associated with at least one of: Listen Before Talk (LBT) channel, LBT sub-band, bandwidth part (BWP), cell, carrier, cell group, service, Logic Channel (LCH), and/or Logical Channel Group (LCG).

46. The method of claim 41, further comprising receiving a report indicating a SR triggering cause from the terminal device.

47. The method of claim 41, further comprising transmitting at least one updated configured grant to the terminal device.

48. A terminal device, comprising:
processing circuitry;
memory containing instructions executable by the processing circuitry whereby the terminal device is operative to:
trigger a scheduling request (SR) to request an uplink grant upon a preconfigured number of uplink transmission failures when using configured grants; and
transmit the SR to a network node.
